(19) United States
(12) Patent Application Publication
(10) Pub. No.: US 2005/0255990 A1
(43) Pub. Date: Nov. 17, 2005

(54) Production of polyoxymethylene and suitable(III) catalysts

(76) Inventor: Gerrit Luinstra, Mannheim (DE)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/510,476

(22) PCT Filed: Apr. 10, 2003
(86) PCT No.: PCT/EP03/03744

§ 371 Date: Oct. 7, 2004

(30) Foreign Application Priority Data
Apr. 11, 2002 (DE) 102 15 976.9

(51) Int. Cl. B01J 31/00; C08G 65/34

(52) U.S. Cl. 502/150; 502/152; 528/425

(57) ABSTRACT

A process is described for preparing polyoxymethylene by contacting a formaldehyde source with a catalyst of the formula I 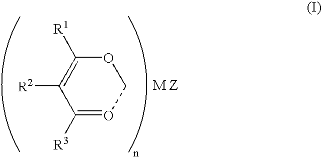 where
M is TiO, ZrO, HfO, VO, CrO₂, MoO₂, WO₂, MnO₂, ReO₂, Fe, Ru, Co, Rh, Ir, Ni, Pd, Pt, Cu, Zn, Cd, Hg, Sn, SnO or PbO;
R¹, R² and R³ are independently a radical which is selected from H, alkyl, aryl and aralkyl and the radical may be partly or fully halogenated; Z is an anion; and n is 1 or 2.

The present invention relates to a process for preparing polyoxymethylene by contacting a formaldehyde source with a catalyst and a catalyst suitable therefor.

The polyoxymethylene resulting from the homopolymerization of formaldehyde is a polymer having repeating CH₂O units. When formaldehyde is copolymerized with cyclic ethers or formals, the CH₂O chains are interrupted by units which stem from the cyclic ethers or formals. The term polyoxymethylene is used hereinbelow both for the homo- and for the copolymer.

Polyoxymethylene and processes for preparing it by homo- or copolymerizing formaldehyde using metal complexes as catalysts are well known.

For instance, WO 94/09055 describes the polymerization of trioxane in the presence of ytterbium triflate. A disadvantage is that the yields are low even when the reaction times are long.

U.S. Pat. No. 3,457,227 describes trioxane homopolymerization and copolymerization with cyclic ethers using dioxomolybdenum diacetylacetonate as catalyst. A disadvantage is that the catalyst is easily deactivated by impurities or water traces in the trioxane. The trioxane used accordingly has to be very pure.

DE 2 226 620 describes the polymerization of formaldehyde using a copper acetylacetonate complex. In this case also, virtually water-free formaldehyde has to be used.

U.S. Pat. No. 3,305,529 describes the homo- and copolymerization of formaldehyde in the presence of metal diketonates. However, the yields obtained are unsatisfactory for an industrial process.

DE 727 000 describes the homopolymerization of formaldehyde or trioxane and the copolymerization thereof with cyclic formals using a catalyst which comprises titanyl acetylacetonate and iron(II) acetylacetonate and/or iron(III) acetylacetonate. In this case also, the monomers used should be substantially water-free.

The prior art processes have long induction times, in particular when the formaldehyde source is not highly pure. This may even lead to no polymerization occurring at all. The induction time is the time which elapses from the mixing of the formaldehyde source with the catalyst to the “light-off” of the polymerization. A long induction time leads to long residence times of reactants in the reactor which is uneconomical.

It is an object of the present invention to provide a process having a short induction time which is preferably tolerant toward impurities and water traces in the formaldehyde source.

We have found that this object is achieved by a process for preparing polyoxymethylene by contacting a formaldehyde source with a catalyst of the formula I, 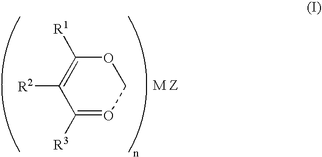
where
M is TiO, ZrO, HfO, VO, CrO₂, MoO₂, WO₂, MnO₂, ReO₂, Fe, Ru, Co, Rh, Ir, Ni, Pd, Pt. Cu. Zn, Cd, Hg, Sn, SnO or PbO;
R¹, R² and R³ are each independently a radical which is selected from H, alkyl, aryl and aralkyl, and the radical may be partly or fully halogenated;
Z is an anion; and
n is 1 or 2.

The present invention further provides a catalyst of the formula I. The remarks hereinbelow relating to the process according to the invention apply correspondingly to the catalyst according to the invention, unless it is clear from the context that this is not the case.

For the purposes of the present invention, the term “alkyl” encompasses linear, branched and cyclic alkyl groups. These are preferably C₁-C₂₀-alkyl, in particular C₁-C₆-alkyl groups, such as methyl, ethyl, propyl, isopropyl, n-butyl, 2-butyl, isobutyl, tert-butyl, n-pentyl and n-hexyl, or C₃-C₈-cycloalkyl, such as cyclopropyl, cyclopentyl, cyclohexyl or cycloheptyl.

The halogenated radicals are preferably chlorinated and/or fluorinated, more preferably fluorinated, in particular perfluorinated radicals, in particular alkyl radicals.

Aryl is preferably C₆-C₁₄-aryl, such as phenyl, naphthyl, anthracenyl or phenanthrenyl and in particular phenyl or naphthyl. The aryl radicals may carry up to three C₁-C₄-alkyl radicals.

Aralkyl is preferably C₇-C₂₀-aralkyl, such as benzyl or phenylethyl. Particular preference is given to benzyl.

In formula I, M is preferably TiO, ZrO, MoO₂, WO₂, Ir or Pd, more preferably MoO₂ or WO₂.

R¹, R² and R³ are preferably each independently C₁-C₆-alkyl which may be partly or fully halogenated, in particular fluorinated, phenyl, benzyl or naphthyl.

Particular preference is given to R¹ and R³ each independently being methyl, tert-butyl, trifluoromethyl, heptafluoropropyl, phenyl or naphthyl. R² is particularly preferably H or methyl.

Particularly preferred catalysts are derived from the following diketones: 2,4-pentanedione, 2,2-dimethyl-3,5-hexanedione, 3-methyl-2,4-pentanedione, 4,4-dimethyl-1-phenyl-1,3-pentanedione, 2,2,6,6-tetramethylheptane-3,5-dione, 4,4,4-trifluoro-1-(2-naphthyl)-1,3-butanedione, 1,1,1,5,5,6,6,7,7,7-decafluoro-2,4-heptanedione and 1,1,1,5,5,5-hexafluoro-2,4-pentanedione.

Z is an anion, preferably an anion derived from a Brönstedt acid whose pKₐ is lower than that of acetic acid, or a non-coordinating anion. The term “non-coordinating anion” is known to those skilled in the art and refers to anions having an effective charge distribution over more than one atom, so that there is no point-center charge.

Z may be, but does not have to be, part of the ligand sphere of the central metal.

Preference is given to Z being a halide, sulfonate of the general formula ROSO₂— where R is alkyl, partly or fully halogenated alkyl or aryl such as trifluoromethanesulfonate, benzenesulfonate or p-toluenesulfonate, carboxylate of the general formula R′COO— where R′ is as defined for R and is more preferably fully halogenated alkyl, in particular perfluorinated alkyl, such as trifluoroacetate, complexed borate such as tetrafluoroborate or tetraphenylborate, complexed phosphate such as hexafluorophosphate, complexed arsenate such as hexafluoroarsenate or complexed antimonate such as hexafluoro- or hexachloroantimonate. Z is in particular chloride or triflate (trifluoromethanesulfonate).

The number n of diketonate ligands in the complex is determined by the condition of charge neutrality of the structure of the formula I. The positive charge of the M grouping which results from the formal oxidation number of the central metal minus the contribution of any doubly negatively charged oxo ligands present has to be compensated by the sum total of the negative charges of the diketonate (or diketonates) and of Z. n is preferably 1.

Preference is given to using the catalyst I in a quantity of from 1 ppm to 1 mol %, more preferably from 5 to 1000 ppm and in particular from 10 to 500 ppm, based on the formaldehyde source. Preference is given to preparing the catalyst I before use in the polymerization. The preparation is effected by customary processes for preparing metal complexes by reacting a metal compound with the appropriate ligands. The ligands may be introduced in any desired sequence. Preference is given to reacting a metal compound, which may optionally contain leaving groups, with a diketonate. The diketonate is generally obtained by reacting the appropriate diketone with a base.

The formaldehyde source used is preferably formaldehyde, trioxane, tetraoxane or paraformaldehyde or a mixture thereof, and more preferably formaldehyde or trioxane or a mixture thereof. Trioxane, the cyclic trimer of formaldehyde, and paraformaldehyde, an oligomer having from 2 to 100 formaldehyde units, are either depolymerized before use in the polymerization reaction or preferably used as such and dissociated in the course of the reaction.

The formaldehyde source preferably has a degree of purity of at least 95%, more preferably at least 99% and in particular at least 99.5%. In particular, the formaldehyde source contains a maximum of 0.002% by weight of compounds having active hydrogen such as water, methanol or formic acid, based on the weight of the formaldehyde source. However, the process according to the invention also tolerates formaldehyde sources having a lower degree of purity and a higher content of compounds having active hydrogen.

The process according to the invention may be carried out as a solution, suspension, gas phase or bulk polymerization.

When the polymerization is carried out in solution or suspension, it is advantageous to select a substantially anhydrous aprotic organic reaction medium which is liquid under the reaction conditions and reacts neither with the catalyst nor with the formaldehyde source. When the polymerization is carried out in solution, the solvent should advantageously also dissolve the catalyst and the formaldehyde source but preferably not dissolve or only sparingly dissolve the polyoxymethylene formed. When the polymerization is carried out in suspension, the formaldehyde source should also be insoluble in the solvent and, if necessary, dispersion auxiliaries are used, in order to achieve better distribution of the formaldehyde source in the reaction medium. Preference is given to selecting the solvent from saturated or unsaturated, linear or branched, aliphatic hydrocarbons which may be partly or fully halogenated, optionally substituted alicycles, optionally substituted fused alicycles, optionally substituted aromatics, acyclic and cyclic ethers, polyether polyols and other polar aprotic solvents such as sulfoxides and carboxylic acid derivatives.

Examples of useful aliphatic hydrocarbons include propane, n-butane, n-pentane, n-hexane, n-heptane, n-decane and mixtures thereof. Examples of useful halogenated hydrocarbons include methylene chloride, chloroform, carbon tetrachloride, dichloroethane or trichloroethane. Useful aromatics include benzene, toluene, the xylenes, nitrobenzene, chlorobenzene and biphenyl. Useful alicycles include cyclopentane, cyclohexane, tetralin and decahydronaphthalene. Examples of useful acyclic ethers include diethyl ether, dipropyl ether, diisopropyl ether, dibutyl ether and butyl methyl ether; useful cyclic ethers include tetrahydrofuran and dioxane. Examples of the useful polyether polyols include dimethoxyethane and diethylene glycol. An example of a useful sulfoxide is dimethyl sulfoxide. The useful carboxylic acid derivatives include dimethylformamide, ethyl acetate, ethyl acrylate and ethylene carbonate.

Particularly preferred solvents for the solution polymerization are selected from the following: n-hexane, cyclohexane, methylene chloride, chloroform, dichloroethane, trichloroethane, benzene, toluene, nitrobenzene, chlorobenzene, dimethoxyethane, dimethyl sulfoxide and ethylene carbonate. All mixtures thereof are also suitable. Particular preference is given to cyclohexane/hexane mixtures.

Preference is given to using the formaldehyde source in the solution polymerization in a concentration of from 20 to 90% by weight, preferably from 25 to 95% by weight and in particular from 60 to 90% by weight, based on the total weight of the solution. The polymerization in solution may also be carried out as a “blow-in” polymerization. This involves continuously blowing the formaldehyde source, in particular formaldehyde gas, into a solution which contains the catalyst.

Preferred reaction media for the heterogeneous suspension polymerization include straight-chain aliphatic hydrocarbons.

The polymerization may also be carried out in bulk when trioxane is used as the formaldehyde source. Trioxane is used as a melt; the reaction temperature and reaction pressure are selected correspondingly.

In the process according to the invention, the sequence in which the formaldehyde source and the catalyst I are introduced into the reaction zone is not of decisive importance. However, preference is given to initially charging the formaldehyde source and adding the catalyst to it.

The polymerization is preferably carried out at a temperature of from −40 to 150° C., more preferably from 0 to 150° C. The solution polymerization and suspension polymerization are carried out in particular at from 20 to 100° C. and especially from 30 to 90° C. The bulk polymerization is preferably carried out at such a temperature that the formaldehyde source, especially trioxane, and the polymer are in the form of a melt. In particular, the temperature, depending on the pressure, is from 60 to 120° C., especially from 60 to 100° C.

The reaction pressure is preferably from 0.1 to 50 bar, more preferably from 0.5 to 10 bar and in particular from 1 to 7 bar.

Useful reaction apparatus include the reactors which are known to those skilled in the art to be useful for the type and conditions of each different polymerization.

The above remarks apply both to the homopolymerization of the formaldehyde source and to the copolymerization of the formaldehyde source with cyclic ethers or formals which will be referred to hereinbelow as comonomers.

Homopolymeric polyoxymethylene tends to thermally degrade, i.e. to depolymerize to oligomeric or monomeric formaldehyde. This is attributed to the presence of hemiacetal functions at the chain ends of the polyoxymethylene. Copolymerization of formaldehyde with comonomers such as cyclic ethers and/or formals can stabilize the polyoxymethylene formed. These comonomers are incorporated in the polyoxymethylene chain. When the polymer is subjected to thermal stress, the polyoxymethylene chain degrades until the chain end is formed by one of the above mentioned comonomers. These are substantially less prone to thermally degrade, so that the depolymerization comes to a stop and the polymer is stabilized. Useful comonomers of this type are cyclic ethers, in particular those of the formula 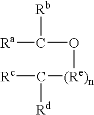
where R^{a}, R^{b}, R^{c} and R^{d} are each independently hydrogen or an optionally halogenated C₁-C₄-alkyl group, R^{e} is a —CH₂—, —CH₂O—, a C₁-C₄-alkyl- or C₁-C₄-haloalkyl-substituted methylene group or a corresponding oxymethylene group and n is an integer from 0 to 3.

Cyclic ethers mentioned only by way of example include ethylene oxide, 1,2-propylene oxide, 1,2-butylene oxide, 1,3-butylene oxide, 1,3-dioxane, 1,3-dioxolane and 1,3-dioxepane, and comonomers mentioned only by way of example include linear oligo- and polyformals such as polydioxolane and polydioxepane.

When they are used, repeat units of the formula 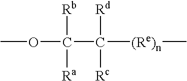
are incorporated into the polyoxymethylene copolymers obtained in addition to the —CH₂O— repeat units stemming from the formaldehyde source.

If desired, a third monomer may be used in addition to the above-described cyclic ethers, preferably a bifunctional compound of the formula 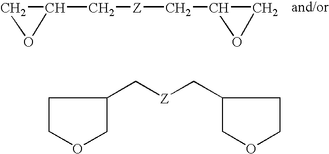
where Z is a chemical bond, —O—, —ORO— (R═C₁-C₈-alkylene or C₂-C₈-cycloalkylene).

To name only a few examples, preferred monomers of this type include ethylene diglycide, diglycidyl ethers and diethers made from glycidylene and formaldehyde, dioxane or trioxane in a molar ratio of 2:1 and also diethers made from 2 mol of glycidyl compound and 1 mol of an aliphatic diol having from 2 to 8 carbon atoms, for example the diglycidyl ethers of ethylene glycol, 1,4-butanediol, 1,3-butanediol, cyclobutane-1,3-diol, 1,2-propanediol and cyclohexane-1,4-diol.

Particular preference is given to using ethylene oxide, 1,2-propylene oxide, tetrahydrofuran, 1,3-dioxane, 1,4-dioxane, 1,3-dioxolane and 1,3-dioxepane, in particular 1,3-dioxepane as comonomers.

The comonomers are preferably used in a quantity of from 0.1 to 40% by weight, more preferably from 0.2 to 10% by weight, in particular from 0.5 to 5% by weight, based on the formaldehyde contained in the formaldehyde source.

The comonomers may either be initially charged with the formaldehyde source or added to the additionally charged catalyst together with the formaldehyde source. Alternatively, they may be added to the reaction mixture consisting of the formaldehyde source and the catalyst.

When cyclic ethers are used as comonomers, there is a risk that these contain peroxides, in particular when they have been stored for a relatively long time before use. Peroxides firstly lengthen the induction time of the polymerization and secondly reduce the thermal stability of the polyoxymethylene formed owing to their oxidative effect. For this reason, preference is given to using cyclic ethers which contain less than 0.0015% by weight, more preferably less than 0.0005% by weight, of peroxides, reported as hydrogen peroxide and based on the quantity of cyclic ether used.

In order to prevent oxidative degradation of the polyoxymethylenes obtained, preference is given to adding sterically hindered phenol antioxidants to them. In principle, useful sterically hindered phenols include all compounds having a phenolic structure which have at least one sterically demanding group on the phenolic ring.

Preference is given to using, for example, compounds of the formula 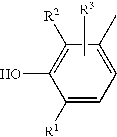
where R¹ and R² are identical or different and are each an alkyl group, a substituted alkyl group or a substituted triazole group and R³ is an alkyl group, a substituted alkyl group, an alkoxy group or a substituted amino group.

Antioxidants of the type mentioned are described, for example, in DE-A 27 02 661 (U.S. Pat. No. 4,360,617).

A further group of preferred sterically hindered phenols is derived from substituted benzenecarboxylic acids, in particular from substituted benzenepropionic acids.

Particularly preferred compounds from this class are compounds of the formula 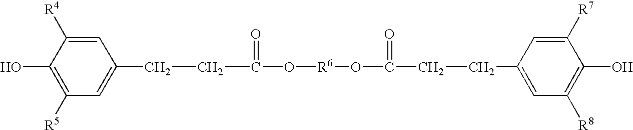
where R⁴, R⁵, R⁷ and R⁸ are each independently C₁-C₈-alkyl groups which may themselves be substituted (at least one of them is a sterically demanding group) and R⁶ is a bivalent aliphatic radical having from 1 to 10 carbon atoms which may also have C—O-bonds in the main chain.

Preferred compounds of this type are

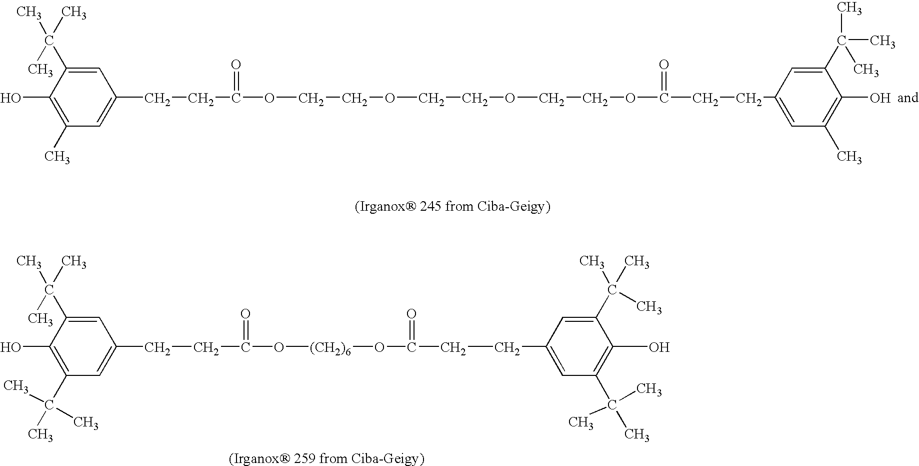

Examples of sterically hindered phenols include: 2,2′-methylene-bis(4-methyl-6-tert-butylphenol), 1,6-hexanediolbis[3-(3,5-di-tert-butyl-4-hydroxyphenyl)-propionate] (Irganox® 259), pentaerythrityl tetrakis[3-(3,5-di-tert-butyl-4-hydroxyphenyl)propionate] and the above-described Irganox® 245.

The following compounds have proven to be particularly effective and are therefore used with preference: 2,2′-methylene-bis(4-methyl-6-tert-butylphenol), 1,6-hexanediolbis[3-(3,5-di-tert-butyl-4-hydroxyphenyl)-propionate] (Irganox® 259), pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-yl-methyl 3,5-di-tert-butyl-4-hydroxycinnamate, 3,5-di-tert-butyl-4-hydroxyphenyl-3,5-distearyl-thiotriazylamine, 2-(2′-hydroxy-3′-hydroxy-3′,5′-di-tert-butylphenyl)-5-chloro-benzotriazole, 2,6-di-tert-butyl-4-hydroxymethylphenol, 1,3,5-trimethyl-2,4,6-tris-(3,5-di-tert-butyl-4-hydroxybenzyl) benzene, 4,4′-methylene-bis(2,6-di-tert-butylphenol), 3,5-di-tert-butyl-4-hydroxybenzyldimethylamine and N,N′-hexamethylene-bis-3,5-di-tert-butyl-4-hydroxyhydrocinnamide.

The sterically hindered phenols which may be used individually or as a mixture may either be added to the monomer mixture or to the finished polymer. In the latter case, the polymer may optionally be melted in order to achieve better dispersion of the antioxidant.

Preference is given to using the antioxidants in a quantity of up to 2% by weight, more preferably from 0.001 to 2% by weight, in particular from 0.005 to 1% by weight, based on the weight of monomer mixture used or polymer obtained.

Another possible way of stabilizing the polyoxymethylene obtained by homopolymerization of a formaldehyde source is to cap the hemiacetal end groups, i.e. convert them to functionalities which do not tend to thermally degrade. To this end, the polyoxymethylene is reacted, for example, with carboxylic acids, carbonyl halides, carboxylic anhydrides, carbonates or hemiacetals, or cyanethylated.

In this variant, the polyoxymethylene is stabilized in a separate step following the polymerization. Preference is accordingly given to stabilizing the polyoxymethylene by copolymerization with the comonomers which requires no separate step.

After the end of the polymerization reaction, preference is given to admixing the catalyst with a deactivator. Useful deactivators include ammonia, aliphatic and aromatic amines, alcohols, basic salts such as alkaline metal and alkaline earth metal hydroxides and carbonates or borax, and also water. The deactivated catalyst and the deactivator are then separated from the polymer, preferably by washing with water or an organic solvent such as acetone or methylene chloride. However, since the catalyst I may also be used in very small quantities, subsequent treatment of the polyoxymethylene to remove the catalyst may optionally also be omitted.

After the end of the polymerization reaction, excess monomer which is still present in the reaction zone may be removed, for example, by distillation, by purging with a gas stream, for example air or nitrogen, by degassing, by solvent extraction or by washing with an aqueous mixture or with an organic solvent such as acetone.

The polyoxymethylene is generally recovered by removing the solvent or, in the case of bulk polymerization, by cooling and optionally chipping the melt. A preferred workup for bulk polymerization comprises the discharge, cooling and chipping of the polymer melt at elevated pressure and in the presence of a liquid, in particular of water, and is described in German patent application DE-A-100 06 037 which is fully incorporated herein by way of reference.

In the process according to the invention, induction times are obtained which are in the optimal range for industrial applications of from a few seconds to a few minutes. At the same time, the catalyst quantity required is small. The polyoxymethylene preparable according to the invention has number average molar masses Mₙ of well above 10,000 g/mol. The number average molar mass Mₙ is preferably at least 10,000 g/mol, more preferably at least 12,000 g/mol. The weight average molar mass is preferably at least 40,000 g/mol, more preferably at least 50,000 g/mol. The polydispersity index PDI (M_{w}/Mₙ) is preferably less than 8, more preferably less than 7.

The examples hereinbelow illustrate the process according to the invention.

1. Synthesis for Catalysts

1.1 Synthesis of MoO₂(diketonate)Cl (Z¹═Cl)

0.5 mmol of the diketone specified in Table 1 were dissolved in 2.0 ml of ethanol, mixed with 0.5 mmol of sodium ethoxide in 1.2 ml of ethanol and agitated at 50° C. for 10 min. The ethanol was then evaporated at this temperature under reduced pressure and tetrahydrofuran added. The tetrahydrofuran was likewise vaporated and replaced by fresh tetrahydrofuran. This step was repeated once more. The sodium diketonate solution obtained was cooled to −5° C. and admixed with 0.5 mmol of MoO₂Cl₂ in 2 ml of tetrahydrofuran. After 20 min, the temperature was increased to 24° C. After sedimenting the resulting precipitate, 1.750 ml of the supernatant were removed, the solvent removed under reduced pressure and replaced by 1.75 ml of trichloroethane. The trichloroethane was likewise removed and replaced by fresh trichloroethane. This step was repeated once more. The solution obtained in this manner was used in the polymerization reaction.

1.2 Synthesis of MoO₂(diketonate)OSO₂CF₃ (Z²=OSO₂CF₃)

Up to the sedimentation of the precipitate formed, the procedure was as described in Example 1.1.

1.750 ml of the supernatant were removed and admixed with 0.218 mmol of silver triflate in 1.75 ml of tetrahydrofuran at room temperature. The resulting precipitate was removed, the solvent removed under reduced pressure and 1.75 ml of trichloroethane added. The trichloroethane was likewise removed and replaced by fresh trichloroethane. This step was repeated once more. The solution obtained in this manner was used in the polymerization reaction.

The following diketones were used for catalyst synthesis: 2,4-pentanedione, 2,2-dimethyl-3,5-hexanedione, 3-methyl-2,4-pentanedione, 4,4-dimethyl-1-phenyl-1,3-pentanedione, 2,2,6,6-tetramethylheptane-3,5-dione, 4,4,4-trifluoro-1-(2-naphthyl)-1,3-butanedione, 1,1,1,5,5,6,6,7,7,7-decafluoro-2,4-heptanedione and 1,1,1,5,5,5-hexafluoro-2,4-pentanedione.

2. Polymerization

2.1 Bulk Polymerization

2 ml of liquid trioxane and 200 μl of butanediol formal were admixed at 80° C. with 100 μl of the catalyst solution from 1.1 or 1.2. The time between addition of the catalyst and the onset of cloudiness was measured as the induction time. The conversion was substantially quantitative and the polymer obtained as a solid. In the following table, the induction times are measured and also the number average and weight average molar masses of the polyoxymethylene obtained and the polydispersity index (PDI=M_{w}/Mₙ) are reported.

TABLE 1

| | Induction | | | | | | | |
|---|---|---|---|---|---|---|---|---|
| Diketonate | time [s] | | Mₙ [kg/mol] | | M_{w} [kg/mol] | | PDI | |
| R¹(CO)CR²(CO)R³ | Z¹ | Z² | Z¹ | Z² | Z¹ | Z² | Z¹ | Z² |
| Me/H/Me | 53 | 32 | 17.3 | 15.7 | 95 | 75 | 5.5 | 4.8 |
| Me/H/t-Bu | — | 34 | — | 10.8 | — | 67 | — | 6.2 |
| t-Bu/Me/Me | 217 | 28 | 10.2 | 15.8 | 71 | 81 | 7.0 | 5.1 |
| t-Bu/H/Ph | 513 | 5 | 16.1 | 16.7 | 51 | 65 | 5.7 | 4.1 |
| t-Bu/H/t-Bu | — | 12 | — | 16.4 | — | 67 | — | 4.1 |
| CF₃/H/Naph | 421 | 33 | 15.1 | 13.5 | 100 | 86 | 6.6 | 6.4 |
| CF₃/H/C₃F₇ | 127 | 24 | 15.6 | 13.0 | 102 | 60 | 6.5 | 4.6 |
| CF₃/H/CF₃ | 142 | 5 | 15.5 | 14.6 | 57 | 58 | 5.0 | 2.0 |

Z¹ = Cl
Z² = OSO₂CF₃
Me = Methyl
t-Bu = tert-Butyl
Ph = Phenyl
Naph = 2-Naphthyl

2.2 Solution Polymerization

1200 μl of a solvent or a binary solvent mixture (solvents and solvent mixtures are specified in the following Table 2) are initially charged and 2 ml of liquid trioxane and 60 μl of butanediol formal are added at 80° C. 0.015 μl of 2,2,6,6-tetramethylheptanedionedioxomolybdenum trifluoromethanesulfonate in trichloroethane was added to the reaction solution. The time between the addition of the catalyst solution and cloudiness was measured as the induction time. After removal of the solvent by filtration or evaporation, the product was isolated as a solid and washed with acetone and/or aqueous sodium carbonate. In Table 2, the induction times measured and also the number average and weight average molar masses of the polyoxymethylene obtained and the polydispersity index are reported.

TABLE 2

| | Solvent [μl] | | | | Induction | Mₙ | M_{w} | |
|---|---|---|---|---|---|---|---|---|
| Run No. | Hexane | CH¹ | Toluene | Tri² | time [min] | [kg/mol] | [kg/mol] | PDI |
| 1 | 1200 | | | | 0.18 | 11 | 59 | 5.4 |
| 2 | 800 | 400 | | | 0.36 | 9.8 | 55 | 5.6 |
| 3 | 800 | | 400 | | 1.8 | 12.5 | 51 | 4.1 |
| 4 | 800 | | | 400 | 4.5 | 14.5 | 64 | 4.4 |
| 5 | 400 | 800 | | | 0.14 | 15.8 | 76 | 4.8 |
| 6 | 400 | | 800 | | 0.6 | 10.5 | 43.9 | 4.2 |
| 7 | 400 | | | 800 | 1 | 12.6 | 74 | 5.9 |
| 8 | | 1200 | | | 0.5 | 16.1 | 80 | 5.0 |
| 9 | | 800 | 400 | | 1.8 | 9.4 | 55 | 5.9 |
| 10 | | 800 | | 400 | 2.1 | 16.3 | 74 | 4.5 |
| 11 | | 400 | 800 | | 0.6 | 11 | 40.7 | 3.7 |
| 12 | | 400 | | 800 | 4 | 15.7 | 93 | 5.9 |
| 13 | | | 1200 | | 1 | 13.6 | 44.8 | 3.3 |
| 14 | | | 800 | 400 | 1.4 | 11 | 39.2 | 3.6 |
| 15 | | | 400 | 800 | 6.3 | 11.6 | 44.5 | 3.8 |
| 16 | | | | 1200 | 28 | 11 | 45.3 | 4.1 |

CH¹ = Cyclohexane
Tri² = 1,1,1-Trichloroethane

3. Comparative Experiments
3.1 Preparation of MoO₂(diketonate)₂

0.35 mmol of sodium ethoxide were dissolved in 1.2 ml of ethanol, admixed with 0.35 mmol of the diketone specified in Table 3 in 2.0 ml of ethanol and agitated at 50° C. for 10 min. The ethanol was then evaporated at this temperature under reduced pressure and tetrahydrofuran added. The tetrahydrofuran was likewise evaporated and replaced by fresh tetrahydrofuran. This step was repeated once more. The sodium diketonate solution obtained was cooled to −5° C. and admixed with 0.16 mmol of MoO₂Cl₂ in 2 ml tetrahydrofuran. After 20 min, the temperature was increased to 64° C. After sedimenting the resulting precipitate, the supernatant was decanted and filtered. The tetrahydrofuran was removed under reduced pressure and replaced by trichloroethane. The trichloroethane was likewise removed and replaced by fresh trichloroethane. This step was repeated once more. The solution obtained in this manner was used in the polymerization reaction.

3.2 Bulk polymerization using the catalyst from 3.1

From 2 to 2.5 ml of trioxane and from 200 to 250 l of butanediol formal were admixed at 80° C. with from 100 to 200 μl of the catalyst solution from 3.1. The time from the addition of the catalyst solution and the onset of cloudiness was measured as the induction time. The workup was effected as described under 2.1. In the following Table 3, the induction times measured, the yield and the number average and weight average molar masses of the polyoxymethylene obtained and also the polydispersity index are reported.

TABLE 3

| Diketonate | Induction | | | | |
|---|---|---|---|---|---|
| R¹(CO)CR²(CO)R³ | time [min] | Mₙ [kg/mol] | M_{w} [kg/mol] | PDI | Yield [%] |
| Me/H/Me | 1.5 | 13.6 | 47.1 | 3.5 | 100 |
| tBuPh/H/MeOPh | 10 | 14.2 | 56.0 | 3.9 | — |
| Me/Me/Me | 5 | 8.4 | 73.3 | 8.7 | — |
| Ph/H/C₁₇H₃₅ | 40 | 3.2 | 8.8 | 2.8 | 52 |
| Ph/H/Ph | 5-20 | 5.6 | 19.2 | 3.4 | 95-100 |
| t-Bu/H/t-Bu | 15 | 13.7 | 70.2 | 5.1 | 95 |
| Ph/H/t-Bu | — | — | — | — | — |
| CF₃/H/Naph | (1)*-10 | 6.8 | 39.2 | 5.8 | 87-91 |
| | | 15.6* | 53.7* | 3.4* | |

*contains MoO₂(CF₃(CO)CH(CO)C-Naphthyl)Cl
“—”: no polymer formation

As comparison of Tables 1 and 2 with Table 3 shows, the catalysts according to the invention give shorter induction times than those of the prior art.

1. A process for preparing polyoxymethylene by contacting a formaldehyde source with a catalyst of the formula I 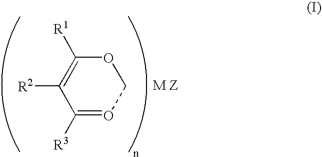
where
M is TiO, ZrO, HfO, VO, CrO₂, MoO₂, WO₂, MnO₂, ReO₂, Fe, Ru, Co, Rh, Ir, Ni, Pd, Pt, Cu, Zn, Cd, Hg, Sn, SnO or PbO;
R¹, R² and R³ are each independently a radical which is selected from H, alkyl, aryl and aralkyl, and the radical may be partly or fully halogenated;
Z is an anion; and
n is 1 or 2.

2. A process as claimed in claim 1 where
M is MoO₂ or WO₂.

3. A process as claimed in claim 1 where
R¹, R² and R³ are each independently H, C₁-C₆-alkyl which may be partly or fully halogenated, phenyl, benzyl or naphthyl.

4. A process as claimed in claim 3 where R¹ and R³ are each independently methyl, tert-butyl, trifluoromethyl, pentafluoroethyl, heptafluoropropyl, phenyl or naphthyl.

5. A process as claimed in claim 4 where R² is H or methyl.

6. A process as claimed in claim 1 where
Z is a halide, sulfonate of the formula OSO₂R, where R is alkyl, partly or fully halogenated alkyl or aryl, complexed borate, complexed phosphate, complexed arsenate or complexed antimonate.

7. A process as claimed in claim 6 where
Z is OSO₂CF₃ or chloride.

8. A process as claimed in claim 1 where the formaldehyde source is formaldehyde, trioxane or paraformaldehyde.
